(19) United States
(12) Patent Application Publication
(10) Pub. No.: US 2011/0232775 A1
(43) Pub. Date: Sep. 29, 2011

(54) FLOW THROUGH HUMIDIFIER RECIRCULATING PUMP

(76) Inventors: David R. Chale, North York (CA); Hao Wang, Aurora (CA); Jinmei Chen, Xuanwu District (CN)

(21) Appl. No.: 12/731,080

(22) Filed: Mar. 24, 2010

(51) Int. Cl. B08B 3/04; F24F 6/00; B01F 3/04

(52) U.S. Cl. 137/15.05; 261/36.1; 261/151

(57) ABSTRACT

A housing containing a reservoir can be mounted to receive water from an outlet port of a humidifier system. A pump having a pump inlet hydraulically connected to the reservoir volume and a pump outlet adapted to connect to an inlet port on the humidifier system can be controlled to deliver water to the humidifier based on a control signal received at a processor. The reservoir can be flushed based on one or more of an elapsed operating time since the last flush and a total time since the last flush. Flushing can be performed using a re-fill port adapted to receive fresh water from an external water source and draining process that can include creating a siphoning action that causes the water to drain from the reservoir volume. Flow of fresh water into the re-fill port can also be controlled to maintain a proper working water level in the reservoir volume. Related systems, apparatus, methods, and/or articles are also described.

### FIELD

The subject matter described herein relates to flow-through humidifier recirculating pumps, for example add-on re-circulating pumps that can contribute to water conservation by capturing and recirculating water used in a humidifier as part of a heating, ventilation, or air conditioning system.

### BACKGROUND

Currently available drain systems for reservoir type humidifiers typically make room for fresh water by flushing the water in an otherwise captive container. The net result of such actions is generally an increase in the amount of water that is sent to waste. Many existing drain systems are also meant for a use in a reservoir or drum type humidifier and are not applicable to a flow-through humidifier that does not include a reservoir. Currently available humidifier systems also typically drain a water reservoir on a preset timed basis or when the water conductivity, which increases with a build-up of mineral content in the unevaporated water, in the reservoir reaches a pre-determined level. The drain system typically does not communicate with the humidification cycle and is incapable of leaving the reservoir empty between cycles. Bacterial growth can become a problem in such systems in which standing water remains in the reservoir for an extended time between humidification cycles.

### SUMMARY

In a first aspect, a system includes a housing adapted to be mounted below an outlet port of a humidifier system, a pump having a pump inlet hydraulically connected to the reservoir volume and a pump outlet adapted to connect to an inlet port on the humidifier system, flushing means for removing water from the reservoir volume, a re-fill port adapted to receive fresh water from an external water source, re-filling means for controlling flow of the fresh water into the re-fill port to maintain a proper working water level in the reservoir volume, and a processor adapted to receive from the humidifier system a control signal indicating whether the humidifier system requires water. The housing includes a water inlet in a top surface that is adapted to receive water drained from the outlet port of the humidifier system and to direct the water to a reservoir volume within the housing. The processor controls the pump to provide water to the humidifier system via the pump outlet when the control signal indicates a need for water and controls the pump to stop providing water to the humidifier system via the pump outlet when the control signal indicates an end to the need for water. The processor further determines whether a flush of the reservoir volume is necessary, and if so initiates a flushing process that includes shutting off the pump and activating the flushing means.

In an interrelated aspect, a method for conserving water use in a flow-through humidifier system having an inlet port and an outlet port can include collecting water draining from the outlet port into a reservoir volume installed below the humidifier unit, commencing delivery of reservoir water to the inlet port when a control signal indicates that the humidifier system requires humidity, ceasing the delivery of reservoir water to the inlet port when the control signal indicates that the humidifier system no longer requires humidity, monitoring a period of time since the reservoir volume was last flushed, and adding water to the reservoir volume via the re-fill port when the humidifier system requires water. The delivering can include activating a pump having a pump inlet hydraulically connected to the reservoir and a pump outlet connected to the inlet port. When the period of time exceeds a threshold period, addition of water to the reservoir volume via a fresh water re-fill port is stopped, the pump is shut off, and a flushing process is commenced to allow water in the reservoir volume to drain to waste. Alternatively, the flushing process can include starting a drain pump that directs water in the reservoir to drain to waste

In various optional implementations, one or more of the following features can also be included. The re-filling means can include an inlet float valve that includes a float positioned within the reservoir volume to cause a re-fill valve connected to the re-fill port to open when a level of water in the reservoir volume drops below a threshold. The re-filling means can include a re-fill valve controlling passage of water through the re-fill port, one or more floating sensors, a shaft positioned within the reservoir volume or within a tube in hydraulic communication with the reservoir volume. The shaft can at least partially constrain horizontal movement of the one or more floating sensors while allowing a vertical position of the one or more floating sensors to vary relative to the shaft as a level of water in the reservoir volume changes, the shaft can include one or more sensor devices that send signals to the processor to indicate the level of water in the reservoir volume based on the vertical position of the one or more floating sensors relative to the shaft. The processor can command the pump to shut down and the re-fill valve to open to add fresh water to the reservoir volume if the signals indicate that the level of water in the reservoir volume is below a minimum water level. If the signals indicate that the level of water in the reservoir volume is below a minimum water level, the processor can begin a sequence to check for a malfunction in the one or more floating sensors or the one or more sensor devices. If the vertical position of the one or more floating sensors indicates the water level in the reservoir is at or above the maximum water level, the processor can performs functions including commanding the pump to shut down, commanding the drain valve to open and then close to drain water from the reservoir volume, activating a trouble indicator.

The shaft can be positioned within the tube in hydraulic communication with the reservoir volume such that changes to the level of water in the reservoir volume causes changes to a height of water in the tube. The flushing means can include a drain line connected at a first end to the tube at a siphon point and at a second end to a drain port disposed lower than a bottom of the reservoir volume. During the flush, the processor can command the pump to shut off and open the re-fill valve for a period of time to admit water to the reservoir volume to cause the height of water in the tube to exceed the siphon point, thereby creating a siphoning action that drains water from the reservoir volume through the tube and the drain line to drain port. Alternatively, the flushing means can include a siphon line connected at a first end to the reservoir volume proximate a bottom of the reservoir volume and at a second end to a drain port disposed lower than the bottom of the reservoir volume. The siphon line can include a siphon point disposed along the siphon line between the first end and the second end and at a vertical level higher than a maximum operating water level in the reservoir volume. During the flush, the processor can command the pump to shut off and open the re-fill valve for a period of time to admit water to the reservoir volume to cause water in the siphon line to rise above the siphon point, thereby creating a siphoning action that drains water from the reservoir volume through the siphon line to the drain port.

A heater unit that supplies heat energy can be provided so that water delivered to the humidifier system via pump is delivered at an elevated temperature to enhance evaporation in the humidifier system. The heater unit can include a heat transfer element in thermal conduct with water contained within the reservoir volume or an inline heater that is disposed external to the reservoir and that provides heat to water in transit from the pump outlet to connect the inlet port of the humidifier. An override switch connected with the pump can be provided to prevent operation of the heater unit unless the pump is active. The water inlet can further include a replaceable filter for removing one or more of excess calcium, other minerals, bacterial or fungal contaminants, and suspended debris from the water before the water enters the reservoir volume. The processor can determine that the flush of the reservoir volume is necessary based on a total operating time since a previous flush of the reservoir exceeding a threshold period or based on a total clock time since the previous flush of the reservoir exceeding a maximum time between flushes. The processor can receive a value for the threshold period as user input. The reservoir volume can include a removable and replaceable tank.

The subject matter described herein provides many advantages. For example, currently available recirculating pumps for flow-through humidifier can suffer from a build-up of minerals (like calcium) and growth of bacteria in the recycled water. Evaporator pads can become clogged with mineral deposits and thereby decrease in effectiveness in putting moisture into the air and require more frequent replacement. In addition the recirculating pump mechanism, the pump reservoir, and the humidifier itself can require significant maintenance to keep functioning as intended. The current subject matter can substantially reduce and in some cases fully eliminate such problems by providing periodic flushing of the system followed by introduction of fresh water. Water savings can advantageously be realized due to recirculation of the water with only periodic draining as needed to control mineral build-up and bacterial growth. In one example, humidifier running 24 hours per day at 6 gallons·hour⁻¹ and draining once every 6 hours according to an implementation of the current subject matter can save about 120 gallons·day⁻¹ from going to waste. This equates to a saving of 21,600 gallons per household per 6 month humidification season.

A secondary problem with existing recirculating pumps is that they generally run continuously. The current subject matter provides for integration with an existing 24 v control circuit and therefore can be configured to run only when the ambient humidity needs to be increased. This saves energy, provides controlled humidity levels, decreases maintenance, and increases the lifespan of the unit. Currently available recirculating pump can also have fixed flow rates which can be too high or too low for the humidifier to which the pump is connected. The current subject matter can address this issue by controlling the supply flow rate with orifice restrictors which can be installed in the supply line or alternatively by including a variable flow rate pump that is dynamically controllable by a processor.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed embodiments. In the drawings,

FIG. 1 is a diagram illustrating a back perspective view of a re-circulating pump system according to the first implementation;

FIG. 2 is a diagram illustrating a front elevation view of a re-circulating pump system according to a first implementation of the current subject matter;

FIG. 3 is a perspective diagram illustrating a top perspective view of a re-circulating pump system according to a variation of the first implementation;

FIG. 4 is a perspective diagram illustrating a top perspective view of a re-circulating pump system according to a variation of the first implementation;

FIG. 5 is a diagram illustrating a top elevation view of a re-circulating pump system according to a second implementation of the current subject matter;

FIG. 6 is a diagram illustrating a side perspective view of a re-circulating pump system according to the second implementation;

FIG. 7 is a perspective diagram illustrating a bottom perspective view of a re-circulating pump system according to the second implementation;

FIG. 8 is a diagram illustrating a side perspective view of a re-circulating pump system according to the second implementation;

FIG. 9 is a diagram illustrating a front elevation view of a re-circulating pump system according to a third implementation;

FIG. 10 is a diagram illustrating a front perspective view of a re-circulating pump system according to a third implementation;

FIG. 11A and FIG. 11B are diagrams illustrating a cross-sectional and side elevation view, respectively, of a water level sensing apparatus a re-circulating pump system according to a third implementation;

FIG. 12 is a process flow diagram illustrating a method;

FIG. 13 through FIG. 17 are process flow diagrams illustrating operations of a recirculating pump system according to an implementation of the current subject matter; and

FIG. 18 is a process flow diagram illustrating operations of a re-circulating pump system according to another implementation of the current subject matter.

Whenever possible, similar reference numerals are sued to refer to similar aspects of the described subject matter.

### DETAILED DESCRIPTION

The current subject matter includes various implementations of recirculating humidifier pumps, such as for example those for use with flow-thru type humidifiers that are typically used with North American furnaces. Currently available humidifiers typically work by introducing water into a distribution tray from which the water is distributed and allowed to flow over or through an evaporative media where moisture is released into the air passing through the duct work. Water exiting the evaporative media can be directed to a drain tray positioned below the evaporative media from which excess water can be drained to waste. Such humidifiers typically also include a humidistat operated on low voltage (for example 24 volts), the control wiring of which is attached to an electric solenoid switch connected to the humidifier. When the humidistat calls for more humidity, the solenoid switch activates allowing water to flow into the distribution tray from which it is subsequently distributed onto the evaporative media below. Typically in such systems, water will be introduced into the distribution tray for as long as humidification is underway. Most of the introduced water does not evaporate as it passes over the evaporative media and is therefore drained to waste. The systems, apparatuses, methods, techniques, and articles of manufacture disclosed herein feature humidifier pumps that reclaim unused water that would otherwise be drained to waste and re-circulate this reclaimed water into the humidifier for re-use.

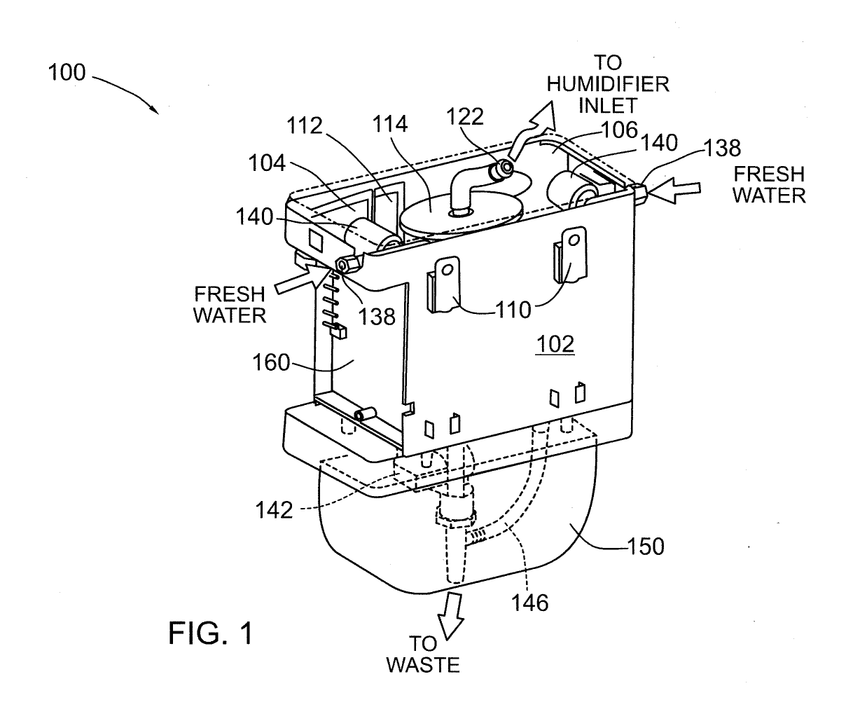

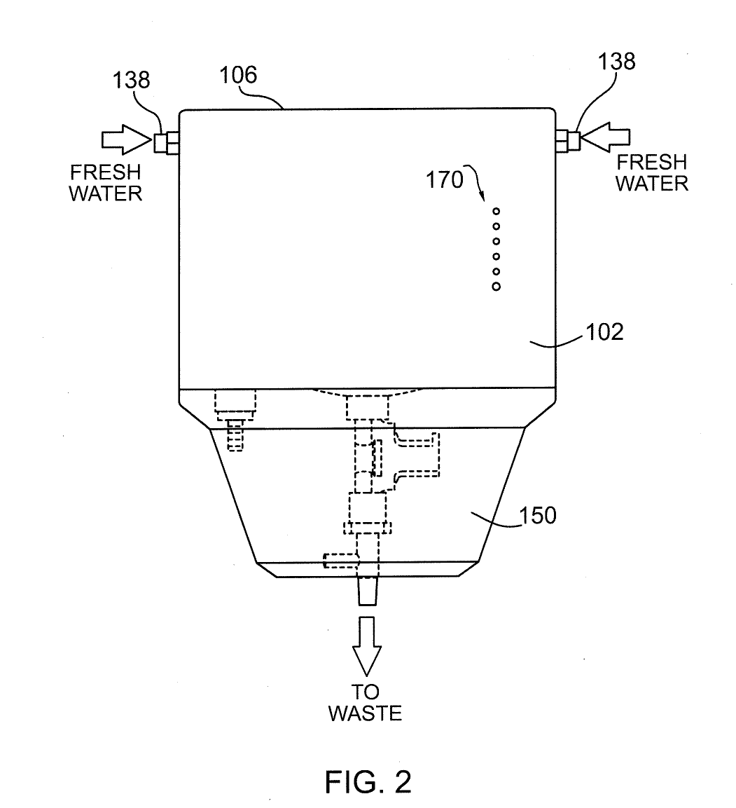

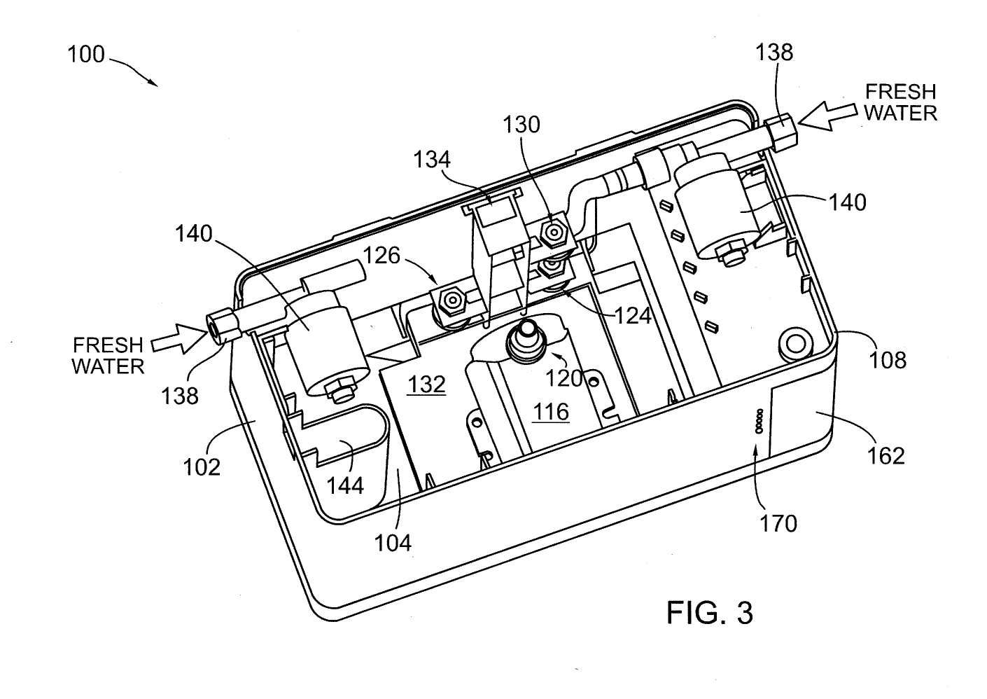

FIG. 1, FIG. 2, and FIG. 3 show three views of an implementation of a re-circulating humidifier pump system 100. As shown, the system includes a housing 102 that encloses a reservoir volume 104. The housing also includes a top cover 106, which is omitted from FIG. 2 and shown as transparent in FIG. 1. The top cover 106 sits atop the housing 102 to enclose the reservoir volume 104 and can be removable to allow access to the reservoir volume 104 and the other components that are housed within and described in greater detail below. A waterproof or watertight gasket or seal 108 can be included so that the reservoir volume 104 is effectively watertight when the top cover 106 is installed.

The housing 102 is adapted to be positioned below the output or drain port or valve of a humidifier (not shown in FIG. 1, FIG. 2, or FIG. 3, hereinafter referred to as the “humidifier outlet”) such that water that exits the humidifier outlet and that would otherwise be sent to waste is collected and either stored for re-use or promptly recirculated to the humidifier. To facilitate mounting of the system 100 to a vertical duct or other support so that it is positioned to collect the water exiting the humidifier outlet, the housing 102 can optionally include one or more hooks, brackets, or other attachment points 110. The system 100 can also optionally be positioned differently and coupled to the humidifier outlet by tubing or some other feature that delivers water from the humidifier outlet to the reservoir volume 104. As shown in FIG. 1, the top cover 106 includes a return inlet 112 that is adapted to receive water exiting the humidifier outlet and can take various forms. The example shown in FIG. 1 includes return inlet 112 formed as a molded recessed basin or cavity in the top cover 106 and adapted to catch water exiting the humidifier outlet. Other configurations of the return inlet 112 are also within the scope of the current subject matter.

The captured water can be introduced into the reservoir volume 104 from the return inlet via a separate replaceable filter 114 that traps excess calcium and/or other minerals which could otherwise clog the various lines in the humidification process. A pump 116 is operatively coupled to the reservoir volume 104. In the example shown in FIG. 1, FIG. 2, an FIG. 3, the pump 116 is housed inside the housing 102 such that it is submerged within water retained in the reservoir volume 104. The pump 116 has an inlet 120 that draws water directly from the reservoir volume 104 into the pump 116 and an outlet 122 adapted to connect to tubing for delivering water pumped from the reservoir volume 104 to an inlet on the humidifier (not shown). Alternatively, the pump 116 can be located outside of the reservoir volume 104 and have an inlet 120 that is connected to the reservoir volume 104 by tubing that carries water from the reservoir volume 104 to the pump 116.

The system 100 also includes one or more indicators that alone or in combination provide an indication of the water level within the reservoir volume 104. In the example shown in FIG. 3, the three floats are mounted within the reservoir volume 104. A first float 124 is set to identify a minimum water level in the reservoir volume 104. This minimum water level can be the minimum sufficient to ensure that the pump inlet 120 always is submerged and so that the pump 116 does not run “dry” which can cause damage or overheating. A second float 126 is set to identify an operative water level that leaves a margin of safety above the minimum level but is not so full that the water retained might overflow the reservoir volume 104. A third float 130 is set to identify a maximum water level, for example to identify a nearly over-full reservoir volume condition.

In the example shown in FIG. 2, a mounting tray 132 for the pump 116 can also include a tower or support 134 to which the floats 124, 126, and 130 can be mounted or suspended. An override switch (not shown) can also be included and connected with the pump 116 to prevent heating from occurring without a command from the electronic unit.

Water can be added to the reservoir volume via a re-fill port 138 that is controlled by a re-fill valve 140, which can optionally be a solenoid valve or some other type of remotely controllable valve. FIG. 1, FIG. 2, and FIG. 3 actually show two such re-fill ports 138 and associated re-fill valves 140 for illustration purposes (one on each side of the reservoir volume to facilitate installations with a fresh water supply on either side of the housing 102). However, one re-fill port 138 and one re-fill valve 140 is sufficient for operation of the current subject matter. The re-fill port 138 is adapted to be connected to a source of fresh water (not shown) from which the reservoir volume 104 can be refreshed or re-filled. Water can be removed from the reservoir volume 104 via a drain valve 142, that can be located at the base of the reservoir volume and that can optionally be a solenoid valve or some other type of remotely controllable valve. Opening of the drain valve 142 causes water in the reservoir volume 142 to flow out of the reservoir volume 104 to waste (not shown). An over-fill drain 144 can also be positioned within the reservoir volume 104 to allow excess water in the reservoir volume 104 to flow to waste via an overflow hose 146 rather than overflowing the reservoir volume and escaping the housing 102. The drain valve 142 and the overflow hose 146 can optionally be contained below the housing 102 in a drain enclosure 150.

The exterior of the housing 102 can optionally include a series of indicator lights 170 or LEDs that provide information about the current function or functions being performed by the recirculation system. Possible indicators 170 are discussed in greater detail below in regards to the system functions controlled by the processor 160. In place of indicator lights, the system 100 could include a display screen readout which conveys information via a user interface. Alternatively, a wired or wireless remote control or interface can receive and display information pertaining to the functions and current state of the system 100. Audible or other non-visual cues can also be provided such as an alarm sound or the like.

The system can also include a circuit board or processor 160 that in the example shown in FIG. 1, FIG. 2, and FIG. 3 is housed in a compartment 162 on the side of the housing 102. The processor controls automatic functioning of the system 100 in response to signals received from the humidifier/furnace system to which the re-circulating pump system 100 is coupled, to commands received from a user.

Commands received from a user can be input via an user interface, such as for example via a computer terminal that communicates over a wired or wireless connection with the processor 160, via one or more buttons on the housing, via a remote control, via a user interface provided on the furnace system or building climate control system with which the processor 160 communicates via signals, or the like. The processor 160 receives signal information from the water level indicators, for example the first, second, and third floats 124, 126, and 130. The processor 160 also provides commands to the pump 116 based on various processes to be performed by the recirculation system. The functions of the processor according to an illustrative implementation of the current subject matter are discussed in greater detail below.

In optional variations, the system 100 can also include a pre-heater (not shown) that adds heat energy to water either before or as it is drawn from the reservoir into the pump inlet 120. In this manner, the vapor pressure of the water is increased and more complete evaporation in the humidifier can be achieved. Optionally, the pre-heater can operate only when the humidifier calls for water. The pre-heater can be positioned within the reservoir 104 and therefore be available to heat water contained in the reservoir 104 prior to delivery to the humidifier via the pump 116. Alternatively, the pre-heater can be an inline heater or heat exchanger that adds heat to the water as it leaves the pump 116 or as the water travels from the outlet port 122 of the pump on its way to the humidifier inlet. Using the pre-heater, the re-circulated water can be warmed to room temperature or alternatively to a higher temperature before delivery to the humidifier system. Doing so can increase comfort levels even if the humidifier capacity is slightly smaller than necessary for the space being humidified. Alternatively, reduced overall operating time can be achieved for a humidifier with an adequate capacity.

Via the processor 160, it can also be possible to control the frequency with which the water in the reservoir volume is flushed to waste via the drain valve 142 to avoid build-up of minerals and/or bacterial growth in the reservoir volume and the humidification system as a whole. The flush frequency of the flush module can in some implementations be user programmable. A default option can be to drain the reservoir volume 104 at the end of every humidification cycle so that the reservoir 104 is maintained empty during time periods when water is not called for by the humidifier.

The water supply flow rate from the pump to the humidifier inlet can in some cases be controllable by the processor 160, for example if a variable flow rate pump 116 is used. Alternatively, flow rate can in some implementations be controlled by inclusion of one or more flow restricting orifices in the tubing leading from the pump outlet 122 to the humidifier inlet.

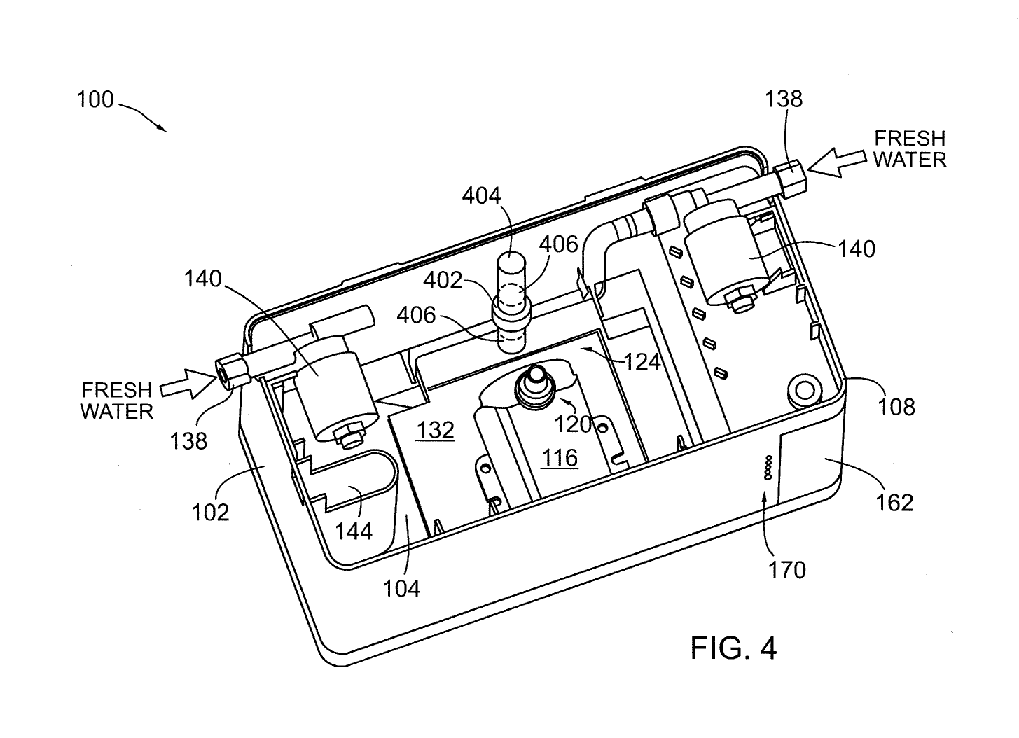

In an alternative implementation that is illustrated in FIG. 4, the three floats shown in FIG. 3 can be replaced by a floating sensor 402 and a support structure 404 that are positioned within the reservoir volume 104 to measure the water level inside the reservoir volume 104. As the level of water in the reservoir volume 104 changes, the floating sensor 402, which can be a magnetic float, is allowed to move in a vertical direction relative to the support structure 404 while the support structure 404 at least partially constrains horizontal motion of the floating sensor 402. One or more integral sensors 406 in or on the support structure 404 can identify the position of the floating sensor 402 and communicate the water level to the processor 160 which can behave as described above. The integral sensors 406 can be electronic, electromagnetic, inductive, or the like.

The processor 160 can command the pump 116 to shut down and the re-fill valve 140 to open if the water level in the reservoir volume 104 is too low as indicated by signals sent from the integral sensors 406 to the processor 160, and processor 160 can command the drain valve 142 to open if the water level in the reservoir is too high. While two integral sensors 406 are shown in FIG. 4, it should be readily understood that any number of sensors can be used. Additionally, a single sensor that measures the position of the floating sensor 402 along the support structure 404 over a continuum can also be included. Other configurations of a water level sensor are also within the scope of the current subject matter. For example, a sensor system need not be limited to a magnetic float on a support shaft. The floating sensor 402 can also include a conductive ring whose vertical position along a support structure 404 is measured inductively.

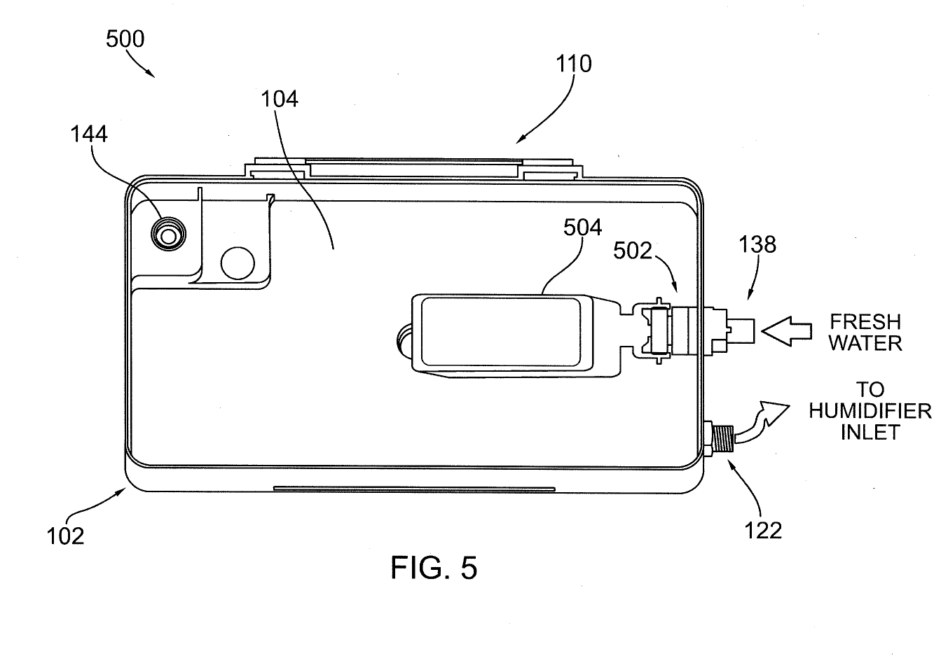

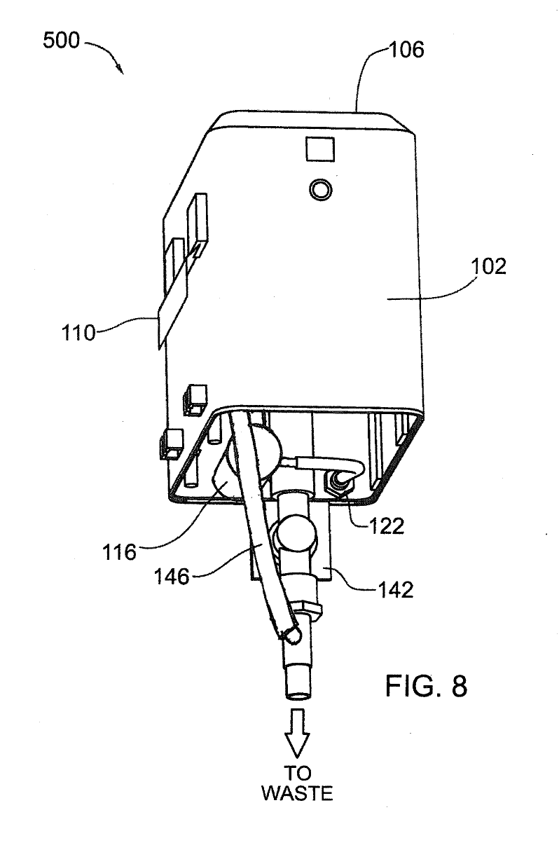

In another alternate implementation illustrated in FIG. 5 through FIG. 8, the first, second, and third floats 124, 126, 130 that provide indications of the water level in the reservoir volume so as to maintain a minimum operating water level in the reservoir volume 104 can be replaced by a float valve 502. The float valve 502 can also replace the re-fill valve 140 of the implementation described above in relation to systems 100 and 400 shown in FIG. 1 through FIG. 4. As in that implementation, the system 500 shown in FIG. 5 through FIG. 8 includes a housing 102 that encloses a reservoir volume 104. The housing also includes a top cover 106, which is omitted from FIG. 5 to show the interior of the reservoir volume 104. The top cover 106 sits atop the housing 102 to enclose the reservoir volume 104 and can be removable to allow access to the reservoir volume 104 and the other components that are housed within and described in greater detail below. A gasket 108 can also be included as discussed above.

The float valve 502 is attached to the re-fill port 138 and can include a float 504 or other device that moves in a vertical direction in response to changes in the water level contained within the reservoir volume 104. When the position of the float 504 indicates a water level in the reservoir volume 104 below a threshold level, the float valve 502 opens to provide additional fresh water to the reservoir volume 104 via the re-fill port 138.

As in the systems 100 and 400 of FIG. 1 through FIG. 4, the housing 102 is adapted to be positioned below the output or drain port or valve of a humidifier such that water that exits the humidifier outlet and that would otherwise be sent to waste is collected and either stored for re-use or promptly re-circulated to the humidifier. Mounting of the system 500 to a vertical duct or other support so that it is positioned to collect the water exiting the humidifier outlet can be facilitated by one or more hooks, brackets, or other attachment points 110. The system 500 can also optionally be positioned differently and coupled to the humidifier outlet by tubing or some other feature that delivers water from the humidifier outlet to the reservoir volume 104. The top cover 106 includes a return inlet 112 that is adapted to receive water exiting the humidifier outlet. An inlet filter can also be incorporated with the return inlet 112 as discussed above.

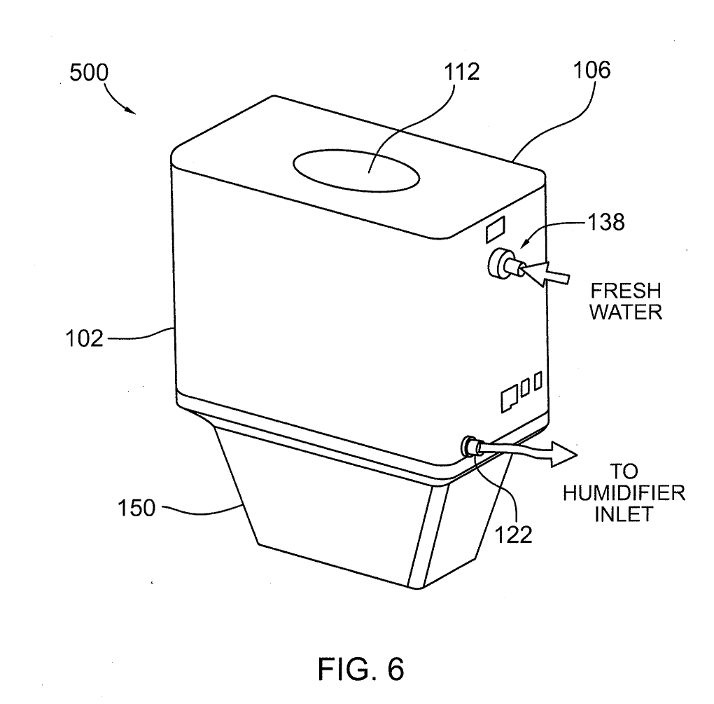

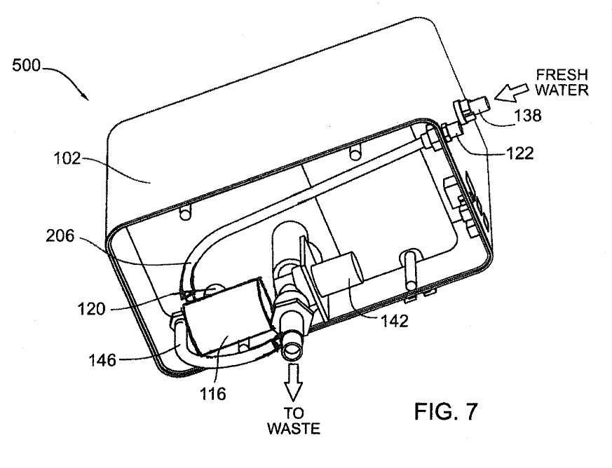

The captured water can be introduced into the reservoir 104 from the return inlet via a separate replaceable filter 114 that traps excess calcium and/or other minerals which could otherwise clog the various lines in the humidification process. Operation of the pump 116 in the system 500 shown in FIG. 5 through FIG. 8 is similar to that discussed above for the systems 100 and 400 shown in FIG. 1 through FIG. 4. The pump 116 can be housed either inside the housing 102 such that it and its pump inlet 120 are submerged within water retained in the reservoir volume 104 or the pump 116 can be located outside of the reservoir volume 104 such that the pump inlet 120 is connected to the reservoir volume 104 by tubing that carries water from the reservoir volume 104 to the pump 116. The pump 116 is shown in FIG. 6 and FIG. 7 positioned below and outside of the reservoir volume 104 with the pump inlet 120 receiving water through floor of the reservoir volume 104. Water exits the pump via pump outlet tubing 206 that carries the water to a pump outlet 122 adapted to connect to tubing for delivering pumped water from the reservoir volume 104 to an inlet on the humidifier (not shown).

As in the systems 100 and 400 of FIG. 1 through FIG. 4, in the system 500 of FIG. 5 through FIG. 8, water can be removed from the reservoir volume 104 via a drain valve 142, typically located at or proximate to the base of the reservoir volume 104. The drain valve 142 can be a solenoid valve or some other type of remotely controllable valve. Opening of the drain valve 142 causes water in the reservoir volume 142 to flow out of the reservoir volume 104 to waste (not shown). An over-fill drain 144 can also be positioned within the reservoir volume 104 to allow excess water in the reservoir volume 104 to flow to waste via an overflow hose 146 rather than overflowing the reservoir volume and escaping the housing 102. The drain valve 142 and the overflow hose can optionally be contained below the housing 102 in a drain enclosure 150. Various features shown in FIG. 1 through FIG. 8 and described herein can be included in other implementations that are within the scope of the current subject matter.

In a further variation, a float valve 502 as shown in FIG. 5 through FIG. 8 can be used in conjunction with a re-fill valve 140, for example as shown in FIG. 1 through FIG. 4, that is connected upstream of the float valve 502, for example between the float valve 502 and the re-fill port 138, to allow for full flushing of the reservoir volume 104 and to allow the reservoir volume to be maintained in a dry, unfilled state between humidification cycles. The re-fill valve 140 can optionally be solenoid valve or another type of remotely controllable valve. The processor 160 can be wired to the pump 116 and further connected either in parallel or serially to the re-fill valve 140. In this example, the processor can control the opening and closing of the re-fill valve 140 such that the float valve 502 admits fresh water to the reservoir volume 104 only when the re-fill valve 140 is open.

In another optional variation, the pump outlet 122 can be positioned above an overflow level of the over-fill drain 144 in the reservoir volume 104 or otherwise configured to prevent siphoning if the output line to the humidifier should become disconnected from the pump outlet 122 or a leak should occur in the line. The pump outlet 122 can optionally be hydraulically connected to the pump 116 via tubing running from the bottom of the reservoir volume 104 through a vertical open ended channel molded into the reservoir volume 104.

In another optional variation, the drain valve 142 can be replaced by a drain pump (not shown) that can be activated by the processor 160 or other means to send the contents of the reservoir volume 104 to waste. The drain pump can optionally be hydraulically connected via tubing running from the bottom of the reservoir volume thru a vertical open ended channel molded into the reservoir volume 104 and into the over-fill drain 144. The over-fill drain 144 can be connected to the overflow hose 146 or other drain hose going to waste.

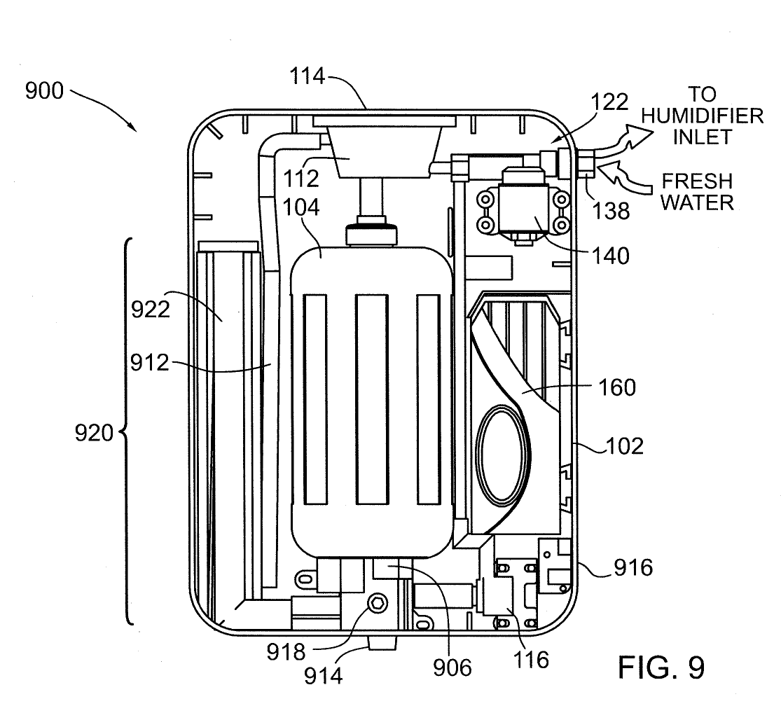

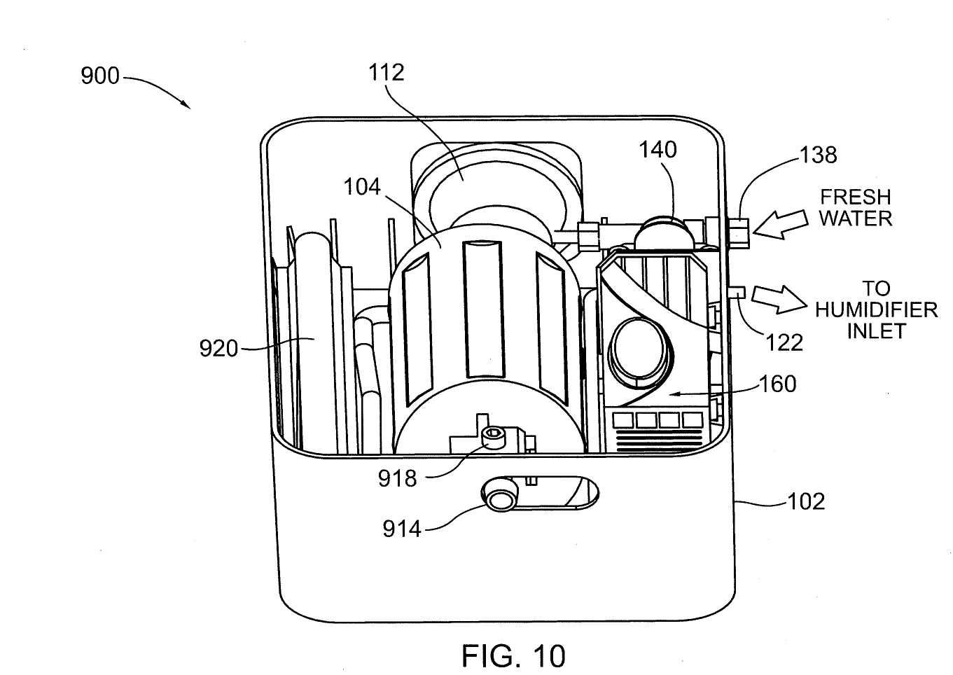

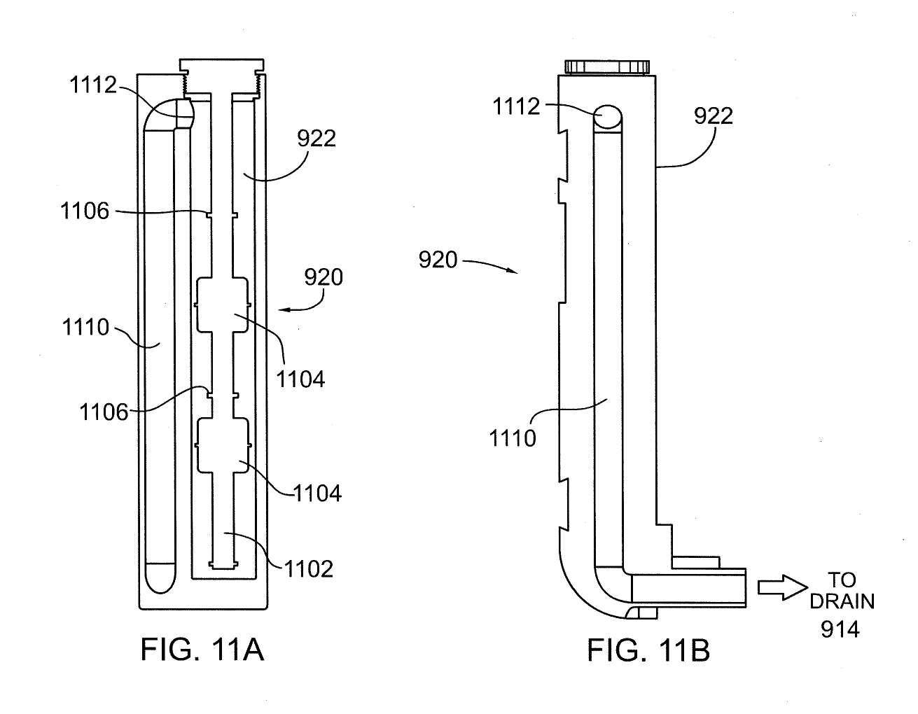

In a further implementation of a humidifier pump system 900 that is illustrated in FIG. 9, FIG. 10, FIG. 11A, and FIG. 11B, the reservoir volume 104 of a humidifier pump system 900 can be provided as a replaceable water cylinder or other tank that can be removed from the housing 102 without complete disassembly of the humidifier pump system 900. The pump 116 can be positioned within the housing 102 but external to the replaceable water cylinder that forms the reservoir volume 104. Activation of the pump 116 draws water from an outlet 906 at or proximate to the bottom of the reservoir volume 104 for delivery to the humidifier inlet via a humidifier water outlet 122. The humidifier pump system 900 shown in FIG. 9 through FIG. 11B also includes an inlet solenoid valve 140 and fresh water inlet 138 that controls addition of fresh water to the reservoir volume 104. It should be noted that in the cross-sectional view of FIG. 9, the humidifier water outlet 122 and the connection to the one or more tubes or other plumbing features are at least partially obscured by the fresh water inlet 138 and the inlet solenoid valve 140. The perspective view of FIG. 10 shows both the outlet and inlet plumbing more clearly.

Also shown in FIG. 9 and FIG. 10 are other features common to the other implementations discussed above. A return inlet 112 is positioned at the top of the housing 102 to collect water draining from the humidifier below which the humidifier pump system 900 is mounted. A replaceable filter 114 can be included with the return inlet 112 to trap excess calcium and/or other minerals or solids that could otherwise clog the various lines in the humidification process. As shown in FIG. 9 and FIG. 10, an overflow line 914 can be provided to divert water from the return inlet to a drain 916 if the amount or rate of delivery of water from an associated humidifier exceeds the capacity of the humidifier pump system 900. The drain can include a drain control 918, which can in some examples be a drain screw or stopcock or, alternatively, a drain solenoid valve 142 as in the previously described implementations. The drain control 918 can be used to completely drain the humidifier pump system 900 for prolonged periods, for example the summer or other warm and humid seasons when heating, and therefore humidification, are not needed. In this manner, prolonged storage of standing water in the humidifier pump system 900 can be avoided.

A controller or processor 160 can be included, either inside the housing 102 or elsewhere with a wired or wireless connection to the valves, pump, etc of the humidifier pump system 900. One or more electrical connectors 916 can be included on the outside of the housing 102, for example a 24V control signal connection for connecting to the humidifier control circuit and an AC or DC power input connection, which can optionally be a 24 V DC input from an AC transformer that supplies line power to the humidifier pump system 900.

Detection of water levels in the reservoir volume 104 (for example the replaceable water cylinder) can be accomplished using a water level sensing apparatus 920. As shown in the FIG. 9 through FIG. 11B, this water level sensing apparatus 920 can include a tube 922 that is at least substantially vertically oriented substantially in parallel with a vertical axis of the reservoir volume 104. The tube 922 is maintained in hydraulic communication with the water in the reservoir volume 104 such that water rises to the same vertical level in the tube 922 as in the reservoir volume 104.

FIG. 11A and FIG. 11B show two views of an example of a water level sensing apparatus 920 in closer detail. Within the tube 922 is oriented a vertical or substantially vertical shaft 1102. One or more floats 1104, each having a central annulus, are positioned annularly on the shaft 1102 such that the floats 1104 move freely up and down the shaft 1104 as the water level in the tube 920 changes in response to changing water levels in the reservoir volume 104. One or more contacts 1106 positioned within the shaft 1104 detect relative positions of the floats 1102. The one or more contacts 1106 can be magnetic, electrical, electronic, inductive, or the like. By including the one or more contacts 1106 within the shaft 1104, the one or more contacts 1106 can be shielded from corrosion, scaling, and/or other negative effects of contact with water.

Flushing of the water in the system can be accomplished by a siphon operation that can make use of the tube 922 of the water level sensing apparatus 920 or alternatively can use a separate siphon tube. If the water level sensing apparatus 920 is used in the siphon operation, a drain line 1110 can be connected to the tube 922 at a siphon point 1112. The drain line 1110 can be routed to the drain 914. When the water level in the tube 920 increases sufficiently to reach the height of the siphon point 1112, a siphon action is created whereby water will flow from the reservoir volume 104 into the tube 922, over the siphon point 1112, and through the drain line 1110 to the drain solely due to gravity without further action of the pump 116. In an alternative implementation in which a separate siphon tube is provided, the separate siphon tube can include a siphon point 1112. When the water level in the separate siphon tube increases sufficiently to reach the height of the siphon point 1112, a siphon action is created whereby water will flow from the reservoir volume 104 through the separate siphon tube over the siphon point 1112, and through the drain line 1110 to the drain solely due to gravity without further action of the pump 116.

In operation, humidifier pump system 900 can function as follows. On a call for humidity from the humidifier, which can be signaled by a 24V control circuit connected to one or more of the electrical connectors 916, the pump 116 operates under command of the controller or processor 160 to provide water to the humidifier through the humidifier water outlet 122. Prior to activating the pump 116, the controller or processor 160 verifies that the one or more floats 1102 and contacts 1106 in the water level sensing apparatus 920 indicate a minimum acceptable water level in the reservoir volume 104. If the one or more floats 1102 and contacts 1106 in the water level sensing apparatus 920 indicate a maximum working water level in the reservoir volume 104, the fresh water inlet valve 140 can be closed so that water from the reservoir volume 104 recirculates to the humidifier. The fresh water inlet valve 140 can remain closed during operation of the pump 116 until the minimum acceptable water level in the reservoir volume 104 is reached, for example due to evaporation in the humidifier. Upon detection of this condition, the controller or processor 160 can command the fresh water inlet valve 140 to open to accept additional fresh water into the reservoir volume 104 via the supply line.

Operation of the system can continue as described above until the call for humidity ends or until a system flush is required. When a flush is required, either due to a timed flush cycle or due to a call for an unscheduled flush, the controller or processor 160 commands the pump 116 to stop. The fresh water inlet valve 140 is opened to accept incoming fresh water that causes the water level in the reservoir volume 104 and tube 922 of the water sensing apparatus 920 to reach the siphon point 1112. The maximum water level sensor is ignored by the controller or processor for a set period of time, for example 10 to 20 seconds to allow flow of water through the tube 920 over the siphon point 1112 and into the drain line 1110 to create a siphon condition. That effectively drains the reservoir volume without requiring action of the pump 116. After the set period of time has elapsed to establish the siphon condition, the fresh water inlet valve 140 is commanded to close.

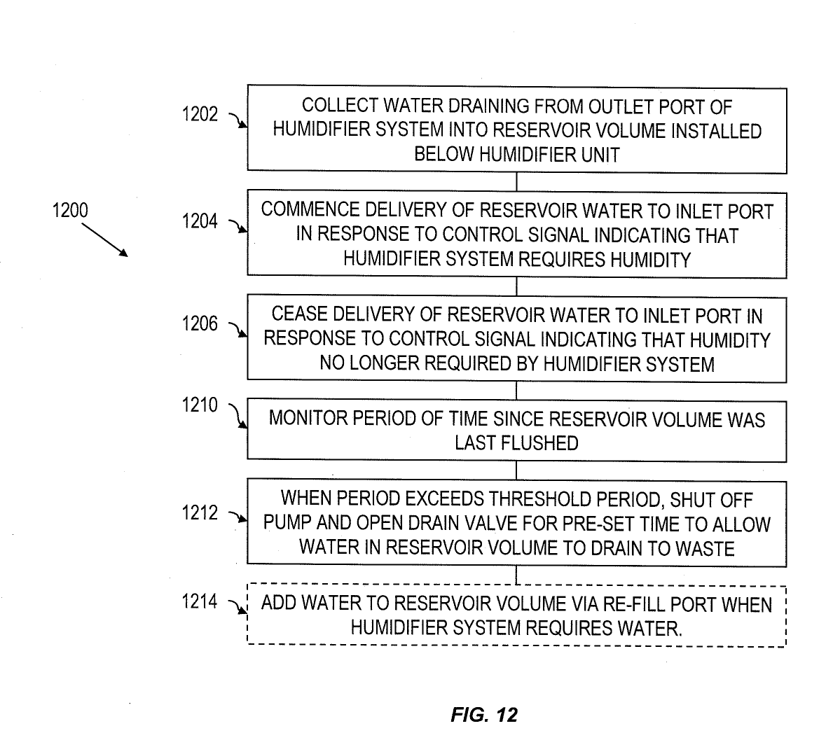

FIG. 12 is a process flow chart 1200 showing features of a method according to an implementation of the current subject matter. At 1202, water draining from the outlet port of a humidifier system is collected into a reservoir volume installed below the humidifier unit. Delivery of reservoir water to the inlet port is commenced at 1204 in response to a control signal indicating that the humidifier system requires humidity. The delivering can include activating a pump having a pump inlet hydraulically connected to the reservoir and a pump outlet connected to the inlet port. At 1206, the delivery of reservoir water to the inlet port can be ceased in response to the control signal indicating that humidity is no longer required by the humidifier system. In one implementation in which a 24 V control circuit is employed to provide the first and the second signals, the change in the second signal can be detection of the 24 V signal ceasing. In other words, presence of the 24 V can indicate that more humidity is needed while absence of 24 V can indicate that humidity is not needed so delivery of water from the reservoir to the inlet port ceases. Alternatively, the control signal can include two or more digital or analog signals that can respectively indicate a need for humidity or a need for no further humidity. Other implementations of a control signal that includes one or more electrical or electronic signals are also possible.

A period of time since the reservoir volume was last flushed is monitored at 1210. At 1212, when the period exceeds a threshold period, a flush sequence is initiated. Addition of fresh water to the reservoir volume via a re-fill port can optionally be ceased as well at 1212. If the re-fill port is closed at 1212, water can optionally be added to the reservoir volume via the re-fill port at 1214 when the humidifier system again requires water. In an alternative or additional implementation, the water in the reservoir volume can be drained to waste either when the period exceeds the threshold period or after a pre-programmed maximum allowable time, such as for example 48 hours.

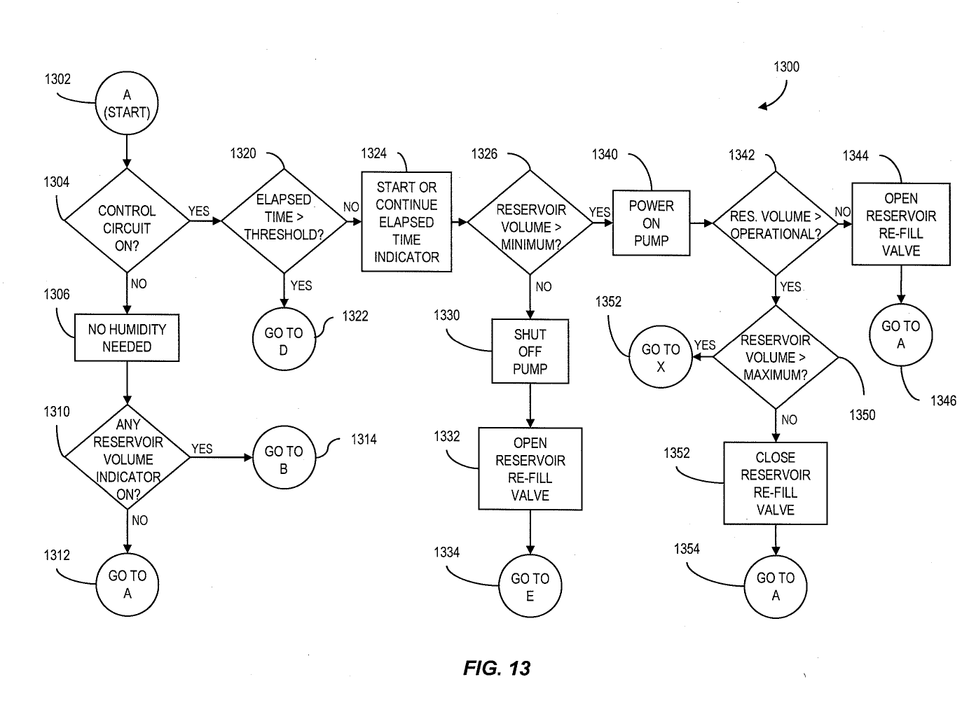

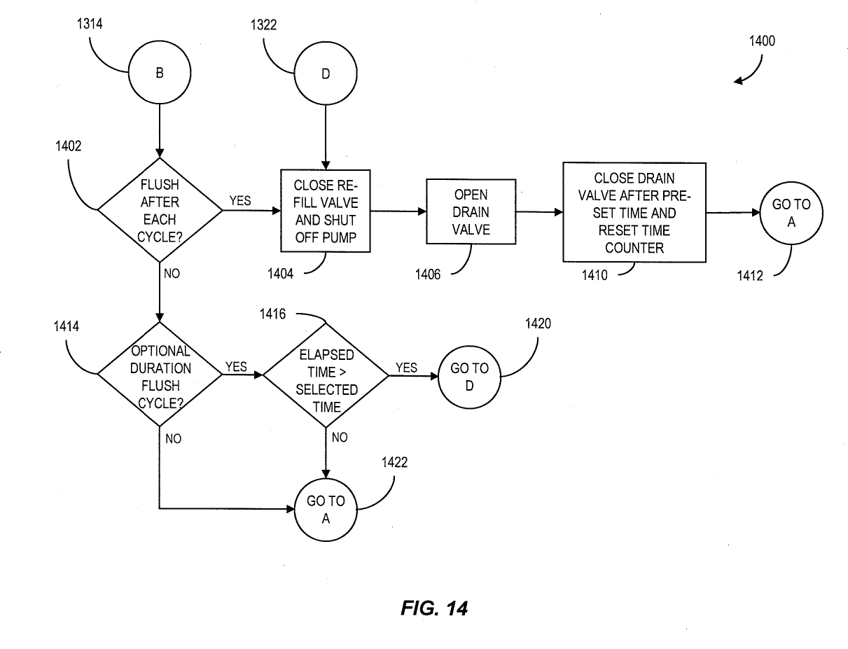

FIG. 13 though FIG. 17 are process flow charts 1300, 1400, 1500, 1600, and 1700 illustrating various features that can be included into the logic flow of an implementation according to the current subject matter and using indicators such as floats 124, 126, and 130 to determine water levels within the reservoir volume. At 1302 the process starts. At 1304, a decision branch determines whether the control circuit is active. If the control circuit is not active, this is interpreted as there being no call for humidity from the furnace/environmental system to which the humidifier system is connected at 1306. An optional “humidity needed” indicator, which can be an LED or one of the indicator lights 170, a message or display on a graphical user interface, an audible indicator, or the like, can be deactivated. Additionally, a counter in the processor 160 that records the elapsed time that the system has used the current volume of water in the reservoir can be stopped. A next decision branch at 1310 determines whether any of the reservoir volume 104 indicators (for example water level floats 124, 126, 130) have been activated. If no, the system returns to start at 1312 and waits for a call for humidity to be indicated by a powering on of the control circuit at 1304. If a reservoir volume detection indicator 124, 126, 130 is determined to have been activated at 1310, at 1314 a reservoir volume maintenance process 1400 is activated at point B in FIG. 14.

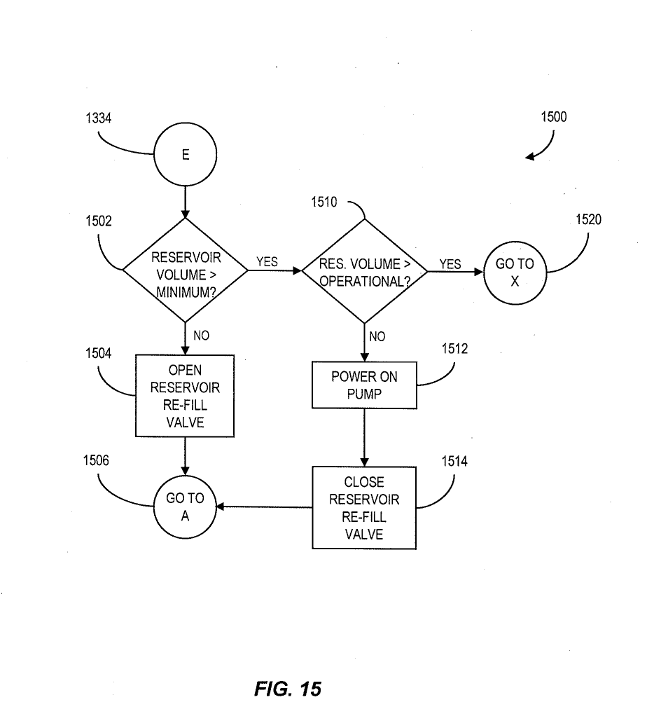

If the control circuit is active at 1304, at 1320 a determination is made whether the elapsed time counter since the reservoir volume 104 was last flushed exceeds a selected threshold time limit for reservoir flushing. If the elapsed time is greater than the selected threshold at 1322, the reservoir volume maintenance process 1400 is activated at point D in FIG. 14. If the elapsed time does not exceed the elected threshold time limit for reservoir flushing, at 1324 the elapsed time counter is started or continued so as to monitor the total active time since the last reservoir flush. If present, the “humidity needed” indicator can be activated. At 1326, a determination is made whether the water level in the reservoir volume 104 is greater than the “minimum” level for pump operation. In one example, this can be a matter of checking whether a low volume float 124 in the reservoir volume 104 gives a positive indication of sufficient water level. If the volume in the reservoir is determined to be below the minimum level at 1326, at 1330 the power to the pump 116 is shut off and an optional “pump active” indicator, such as for example an LED or one of the indicator lights 170, a message or display on a graphical user interface, an audible indicator, or the like, can also be deactivated if present. At 1332 the reservoir re-fill inlet 140 is opened. An optional “reservoir filling” indicator can be activated. At 1334 a filling progress check process 1500 is activated at point E in FIG. 15.

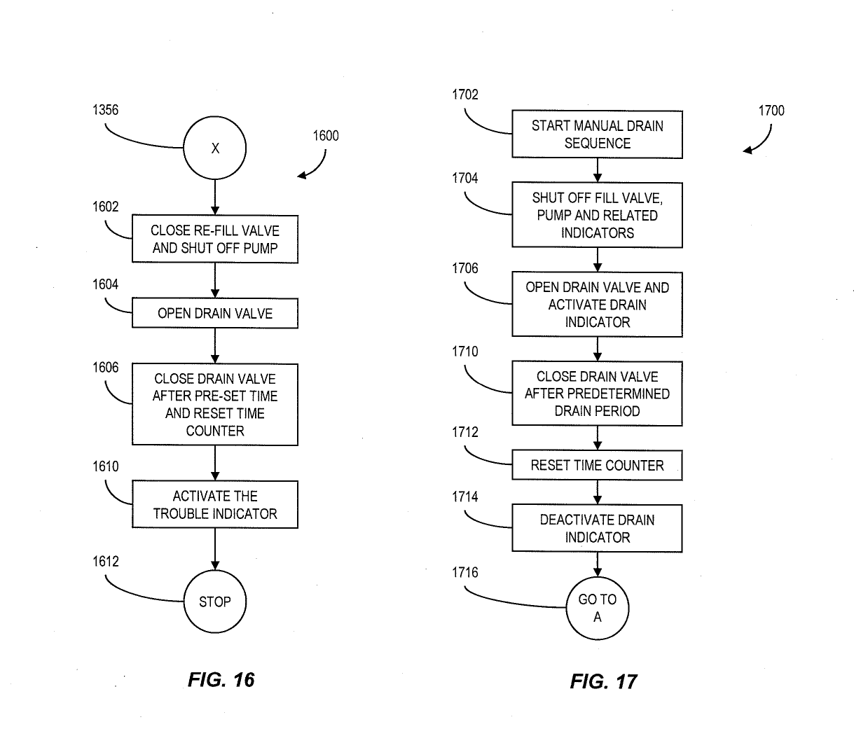

At 1340, if the volume level is above the minimum as determined at 1326, the pump 116 is powered on. The “pump active” indicator can be activated if it is present. At 1342, a determination is made whether the reservoir volume exceeds a middle or optimized operation level. In one example, this determination can include checking whether a middle volume float 126 in the reservoir volume 104 gives a positive indication of sufficient water level for safe operation. If the determination at 1342 is negative, at 1344 the reservoir re-fill inlet 140 is opened and the optional “reservoir filling” indicator can be activated. The process returns to the starting point A at 1346. If the determination at 1342 is affirmative, at 1350 it is determined whether the water level in the reservoir volume 104 is at or above its maximum allowable volume. In one example, this can be a matter of checking whether an upper volume float 130 in the reservoir volume gives a positive indication of a maximum water level occurring in the reservoir volume 104. If the determination at 1350 is negative, at 1352 an optional delay can be programmed (so that the reservoir volume 104 fills to slightly above middle or optimized operation level before re-filling is terminated) and then the reservoir re-fill valve 140 is closed. If present, the optional “reservoir filling” indicator can be deactivated. At 1354 the process returns to the starting point A. If the determination at 1350 is affirmative, at 1356 an emergency reservoir drain and alert process 1600 is activated at point X in FIG. 16.

FIG. 14 shows the process flow for the reservoir volume maintenance process 1400. At 1402, a determination is made whether a user preference has been set for a reservoir flush after each humidification cycle. If yes, at 1404 the reservoir re-fill valve 140 is closed, the optional “reservoir filling” indicator is deactivated if present, and the pump 116 is shut off and the optional “pump active” indicator deactivated if it is present. This step can also occur via branch point D at 1322 in FIG. 13 and FIG. 14. The drain valve 142 is opened at 1406 for a pre-set time, for example 90 seconds, to drain the water in the reservoir volume 104. An optional “reservoir draining” indicator, such as for example an LED or one of the indicator lights 170, a message or display on a graphical user interface, an audible indicator, or the like, can also be activated if present. At 1410, after the pre-set time, the drain valve 142 is closed, the optional “reservoir draining” indicator is deactivated if it is present, and the counter that records the elapsed time that the system has used the current volume of water in the reservoir is reset to zero. At 1412 the process returns to the starting point A in FIG. 13.

If the determination at 1402 is negative, a next determination is made at 1414 whether the flush cycle frequency is set to a user-selectable time period. If yes, at 1416 the elapsed time as indicated by the counter that records the elapsed time that the system has used the current level of water in the reservoir volume 104 is compared with the user-selectable time period to determine whether the elapsed time exceeds the user-selectable time period. If the determination at 1416 is affirmative, the process proceeds to point D at 1420. If the determination at 1416 or at 1414 is negative, at 1422 the process returns to the starting point A in FIG. 13.

FIG. 15 shows the process flow for the filling progress check process 1500. At 1502, a determination is made whether the water level reservoir volume exceeds the middle or optimized operation level, as is described above at 1342. If the determination at 1502 is negative, at 1504 the reservoir re-fill inlet valve 140 is opened and the optional “reservoir filling” indicator can be activated if present. The process returns to the starting point A at 1506. If the determination at 1502 is affirmative, at 1510 it is determined whether the water level in the reservoir volume 104 is at or above its maximum allowable volume, as is described above at 1350. If the determination at 1510 is negative at 1512 the pump 116 is powered on and the “pump active” indicator can be activated if it is present. At 1514 an optional delay can be programmed (so that the reservoir volume 104 fills to slightly above middle or optimized operation level before re-filling is terminated) and then the reservoir re-fill inlet 140 is closed. If present, the optional “reservoir filling” indicator can be deactivated. At 1516 the process returns to the starting point A. If the determination at 1510 is affirmative, at 1520 the emergency reservoir drain and alert process 1600 is activated at point 1602 in FIG. 16.

FIG. 16 shows the emergency reservoir drain and alert process 1600. At 1602, the reservoir re-fill inlet 140 is closed and the optional “reservoir filling” indicator is deactivated if present. At 1604, the reservoir drain valve 182 is opened for a pre-set time, for example 130 seconds, to drain the water in the reservoir. The optional “reservoir draining” indicator can also be activated if present. At 1606, after the pre-set time, the drain valve 142 is closed, the optional “reservoir draining” indicator is deactivated if it is present, and the counter that records the elapsed time that the system has used the current volume of water in the reservoir is reset to zero. A trouble indicator, which can be an LED or one of the indicator lights 170, a message or display on a graphical user interface, an audible indicator, or the like is activated at 1610, and at 1612 the process stops.

FIG. 17 shows a manual drain sequence process 1700. At 1702, the manual drain sequence begins. The manual drain sequence can begin upon receiving a user command to drain the reservoir volume 104. The command can be entered via a user interface, via a switch, button, or the like, or by other comparable means. At 1704, the reservoir re-fill valve 140 is closed and power to the pump 116 is shut off. The “reservoir re-filling” and “pump active” indicators are deactivated if present. At 1706, the drain valve 142 is opened and the “reservoir draining” indicator is activated if it is present. The drain valve 142 is closed at 1710 after a pre-set time, for example 90 seconds, that is sufficient to drain the water from the reservoir volume 104. The counter that records the elapsed time that the system has used the current volume of water in the reservoir volume 104 is reset at 1712 and the “reservoir draining” indicator is deactivated at 1714 if it is present. At 1716 the process returns to the starting point A in FIG. 13.

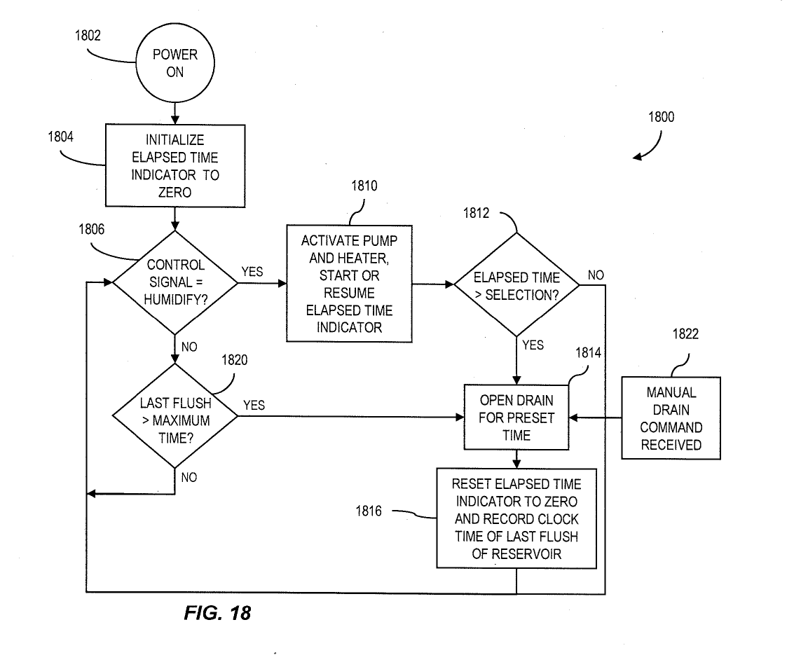

FIG. 18 shows a process flow chart 1800 illustrating a method for operating a re-circulating pump system that includes a float valve 502. At 1802, the system is powered on, for example by being connected to a line source of electrical power. At 1804, an elapsed time indicator is initialized to zero. The elapsed time indicator records the total operating time of the system during a given run of supplying water to a humidifier. A control signal is evaluated at 1806 to determine whether humidity is needed or not. This control signal can optionally be a 24 V control signal that, when active at 24 V, indicates that the humidifier is active and in need of water from the reservoir volume 104 and when not active at 24 V indicates that no water from the reservoir volume 104 is needed by the humidifier. Other methods of conveying information about the need for humidity can also be used. If, at 1806, it is determined that humidity is needed (“yes”), at 1810 the pump 116 and optionally a heater if present are activated and the elapsed time indicator is started (or resumed if it was already running. The elapsed time indicator is evaluated at 1812 to determine whether the elapsed operating time since the start of the humidification cycle exceeds a selected time between reservoir flushes. The selected time can be user selectable, for example with a user control, through a user interface, or the like. If the elapsed time exceeds the selection (“yes” at 1812), at 1814 a drain or drain valve 142 is opened for a preset amount of time to allow water to drain from the reservoir volume 104. This preset amount of time can optionally be approximately 70 seconds or some other time sufficient to allow the reservoir to drain under gravity. An optional delay after the closing of the drain valve 142 can also be included. At 1816, the elapsed time indicator is reset to zero and the clock time of the last flush of the reservoir is recorded. Optionally, a second “clock” timer can be used to record total time since the last flush of the reservoir. The system returns to 1806 to evaluate the control signal to determine whether humidity is or is not currently required.

If the control signal evaluated at 1806 does not indicate that humidity is required, at 1820, the system evaluates the second time counter or otherwise compares the current time to the clock time of the last reservoir flush to a maximum time allowable between flushes of the reservoir. In some implementations, this maximum time can be approximately 48 hours. The maximum time can in some variations be user selectable or can optionally be a fixed time set at manufacture of the device. If the clock time since the last flush exceeds the maximum time at 1820, at 1814 the above-described reservoir draining operation in initiated. The system can also include a manual drain command feature that can be activated via a user interface, a button, or some other user activated control. If at 1822 the manual drain command is received, at 1814 the above-described reservoir draining operation in initiated.

A method for installing a recirculation pump system such as described herein can proceed in some examples as follows. First, the water supply to the humidifier is turned off, and the drain hose is disconnected from the humidifier outlet. The recirculation pump system is mounted or otherwise secured in a position to receive gravity-fed water flow from the humidifier outlet. The mounting can be accomplished optionally using the attachment points 110 or alternatively via one or more hooks, brackets, straps, or the like. The recirculation pump system is advantageously mounted in a level orientation. The top cover 106 of the recirculation pump system is advantageously positioned at a lower height than the humidifier outlet to allow water to drain from the humidifier via a short piece of drain hose. After disconnecting the water supply and low voltage control wiring from inlet valve on the humidifier, these can be reconnected so that the water supply line goes to the re-fill port 138 of the recirculation pump system and the low voltage control wiring is connected to the processor 160 on the recirculation system. The control wiring can include in some implementations the leads from a humidistat and a transformer for the furnace/humidification system. The pump outlet 122 is connected to the humidifier inlet so that water re-circulated from the reservoir volume 104 by the pump 116 is delivered to the evaporation media in the humidifier, for example via a distribution tray or the like in the humidifier.

A drain hose from the humidifier outlet is cut and redirected to the inlet port 112 on the top cover 106 of the recirculation system. The end of the drain hose advantageously terminates far enough into the inlet 112 on the top cover 106 that the hose won't pop out potentially causing a spill. A drain line is connected from the drain valve 142 to waste. An electrical supply cord for the recirculation system is connected to a main outlet, such as for example a 120V outlet. The water supply is turned on and the system is checked for leaks before entering normal operation. As noted above, the flush frequency of the reservoir volume 104 and the water supply flow rate to the humidifier can be user selectable. In some instances, the recirculation system can be shipped with defaults of “flush and leave dry after each humidification cycle.” Other flush frequencies can optionally be selected via a user interface. The volume of water delivered to the humidifier can be controlled with an orifice in the supply line. For example, the recirculation system could ship with a 3.75 GPH orifice installed and a 7 GPH orifice included as a spare part if a higher flow rate is needed.

The subject matter described herein may be embodied in systems, apparatus, methods, and/or articles depending on the desired configuration. Some features of the subject matter described herein can be realized in digital electronic circuitry, integrated circuitry, specially designed ASICs (application specific integrated circuits), computer hardware, firmware, software, and/or combinations thereof. These various features can in some instances be implemented in one or more computer programs that are executable and/or interpretable on a programmable system including at least one programmable processor, which can be special or general purpose, coupled to receive data and instructions from, and to transmit data and instructions to, a storage system, at least one input device, and at least one output device.

Such computer programs (also known as programs, software, software applications, applications, components, or code) can include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed is:

1. A system comprising:
a housing adapted to be mounted below an outlet port of a humidifier system, the housing comprising a water inlet in a top surface, the water inlet being adapted to receive water drained from the outlet port of the humidifier system and to direct the water to a reservoir volume within the housing;
a pump having a pump inlet hydraulically connected to the reservoir volume and a pump outlet adapted to connect to an inlet port on the humidifier system;
flushing means for removing water from the reservoir volume;
a re-fill port adapted to receive fresh water from an external water source;
re-filling means for controlling flow of the fresh water into the re-fill port to maintain a proper working water level in the reservoir volume; and
a processor adapted to receive from the humidifier system a control signal indicating whether the humidifier system requires water, the processor controlling the pump to provide water to the humidifier system via the pump outlet when the control signal indicates a need for water and controlling the pump to stop providing water to the humidifier system via the pump outlet when the control signal indicates an end to the need for water, the processor further determining whether a flush of the reservoir volume is necessary, and if so initiating a flushing process that comprises shutting off the pump and activating the flushing means.

2. A system as in claim 1, wherein the re-filling means comprise an inlet float valve comprising a float positioned within the reservoir volume that causes a re-fill valve connected to the re-fill port to open when a level of water in the reservoir volume drops below a threshold.

3. A system as in claim 1, wherein the re-filling means comprise:
a re-fill valve controlling passage of water through the re-fill port;
one or more floating sensors; and
a shaft positioned within the reservoir volume or within a tube in hydraulic communication with the reservoir volume, the shaft at least partially constraining horizontal movement of the one or more floating sensors while allowing a vertical position of the one or more floating sensors to vary relative to the shaft as a level of water in the reservoir volume changes, the shaft comprising one or more sensor devices that send signals to the processor to indicate the level of water in the reservoir volume based on the vertical position of the one or more floating sensors relative to the shaft; and
wherein the processor commands the pump to shut down and the re-fill valve to open to add fresh water to the reservoir volume if the signals indicate that the level of water in the reservoir volume is below a minimum water level.

4. A system as in claim 3, wherein if the signals indicate that the level of water in the reservoir volume is below a minimum water level, the processor begins a sequence to check for a malfunction in the one or more floating sensors or the one or more sensor devices.

5. A system as in claim 3, wherein if the vertical position of the one or more floating sensors indicates the water level in the reservoir is at or above the maximum water level, the processor performs functions comprising:
commanding the pump to shut down;
commanding the drain valve to open and then close to drain water from the reservoir volume; and
activating a trouble indicator.

6. A system as in claim 3, wherein the shaft is positioned within the tube in hydraulic communication with the reservoir volume such that changes to the level of water in the reservoir volume causes changes to a height of water in the tube.

7. A system as in claim 3, wherein the flushing means comprises: a siphon line connected at a first end to the reservoir volume proximate a bottom of the reservoir volume and at a second end to a drain port disposed lower than the bottom of the reservoir volume, the siphon line comprising a siphon point disposed along the siphon line between the first end and the second end and at a vertical level higher than a maximum operating water level in the reservoir volume, wherein during the flush, the processor commands the pump to shut off and opens the re-fill valve for a period of time to admit water to the reservoir volume to cause water in the siphon line to rise above the siphon point, thereby creating a siphoning action that drains water from the reservoir volume through the siphon line to the drain port.

8. A system as in claim 3, wherein the reservoir volume comprises a removable and replaceable tank.

9. A system as in claim 1, further comprising a heater unit that supplies heat energy so that water delivered to the humidifier system via pump is delivered at an elevated temperature to enhance evaporation in the humidifier system.

10. A system as in claim 9, wherein the heater unit comprises a heat transfer element in thermal conduct with water contained within the reservoir volume or an inline heater that is disposed external to the reservoir and that provides heat to water in transit from the pump outlet to connect the inlet port of the humidifier.

11. A system as in claim 9, further comprising an override switch connected with the pump, the override switch preventing operation of the heater unit unless the pump is active.

12. A system as in claim 1, wherein the water inlet further comprises a replaceable filter for removing one or more of excess calcium, other minerals, bacterial or fungal contaminants, and suspended debris from the water before the water enters the reservoir volume.

13. A system as in claim 1, wherein the processor determines that the flush of the reservoir volume is necessary based on a total operating time since a previous flush of the reservoir exceeding a threshold period or based on a total clock time since the previous flush of the reservoir exceeding a maximum time between flushes.

14. A system as in claim 13, wherein the processor receives a value for the threshold period as user input.

15. A system as in claim 1, wherein the reservoir volume comprises a removable and replaceable tank.

16. A system as in claim 1, wherein the pump comprises the reservoir volume.

17. A system as in claim 16 wherein the reservoir volume and the pump are integral to each other.

18. A method for conserving water use in a flow-through humidifier system having an inlet port and an outlet port, the method comprising:
collecting water draining from the outlet port into a reservoir volume installed below the humidifier unit;
commencing delivery of reservoir water to the inlet port when a control signal indicates that the humidifier system requires humidity, the delivering comprising activating a pump having a pump inlet hydraulically connected to the reservoir and a pump outlet connected to the inlet port;
ceasing the delivery of reservoir water to the inlet port when the control signal indicates that the humidifier system no longer requires humidity;
monitoring a period of time since the reservoir volume was last flushed, and when the period of time exceeds a threshold period, stopping addition of water to the reservoir volume via a fresh water re-fill port, shutting off the pump, and commencing a flushing process to allow water in the reservoir volume to drain to waste; and
adding water to the reservoir volume via the re-fill port when the humidifier system requires water.

19. A method as in claim 18, wherein the control signal is received by a processor that generates commands to the pump to cause the commencing and the ceasing.

20. A method as in claim 18, wherein the flushing process comprises opening a drain valve for a preset time such that the water in the reservoir volume drains to waste.

21. A method as in claim 18, wherein the flushing process comprises starting a drain pump that directs water in the reservoir to drain to waste.

22. A method as in claim 18, comprising monitoring a water level in the reservoir volume based on water level signals received from one or more floats disposed within the reservoir volume or in a tube in hydraulic communication with the reservoir volume, a vertical position the one or more floats indicating whether a minimum water level is present in the reservoir volume to prevent the pump from running dry and whether a maximum operating water level is present in the reservoir volume.

23. A method as in claim 22, wherein the one or more floats are disposed within the tube in hydraulic communication with the reservoir volume such that changes to the level of water in the reservoir volume causes changes to a height of water in the tube.

24. A method as in claim 22, wherein the flushing process comprises:
commanding the pump to shut off; and
opening the re-fill valve for a period of time to admit water to the reservoir volume to cause water to rise in a siphon line connected at a first end to the reservoir volume proximate a bottom of the reservoir volume and at a second end to a drain port disposed lower than the bottom of the reservoir volume to exceed a siphon point disposed along the siphon line between the first end and the second end and at a vertical level higher than a maximum operating water level in the reservoir volume, thereby creating a siphoning action that drains water from the reservoir volume through the siphon line to the drain port.

25. A method as in claim 22, wherein if the vertical position of the one or more floats indicates a water level in the reservoir is below the minimum water level, the method further comprises: commanding the pump to shut down and commanding a re-fill valve connected to the re-fill port to open to add fresh water to the reservoir volume.

26. A method as in claim 22, wherein if the vertical position of the one or more floats indicates a water level in the reservoir is above the maximum water level, the method further comprises: commanding the pump to shut down; commencing the flush process; and
activating a trouble indicator.

27. A method as in claim 18, comprising controlling flow of the fresh water into the re-fill port using an inlet float valve connected to the re-fill port, the inlet float valve comprising a float positioned within the reservoir volume that causes a re-fill valve connected to the re-fill port to open when a level of water in the reservoir drops below a threshold.
